(19) United States
(12) Patent Application Publication
(10) Pub. No.: US 2024/0423227 A1
(43) Pub. Date: Dec. 26, 2024

(54) A NON-CASEIN CHEESE ANALOGUE COMPOSITION

(71) Applicant: SOCIETE DES PRODUITS NESTLE S.A., Vevey (CH)

(72) Inventors: PRAVEEN UPRETI, Twinsburg, OH (US); ISABEL FERNANDEZ FARRES, Barcelona (ES); MARIEL TRAPP, Canton, OH (US); ANTHONY RINI, Solon, OH (US)

(21) Appl. No.: 18/696,859

(22) PCT Filed: Sep. 27, 2022
(86) PCT No.: PCT/EP2022/076811

§ 371 Date: Mar. 28, 2024

Related U.S. Application Data
(60) Provisional application No. 63/250,356, filed on Sep. 30, 2021.

(51) Int. Cl. A23C 20/00; A23J 3/08; A23J 3/14; A23J 3/16; A23J 3/22

(52) U.S. Cl. CPC A23C 20/005; A23C 20/00; A23J 3/08; A23J 3/14; A23J 3/16; A23J 3/225

(57) ABSTRACT

The present invention relates to a non-casein cheese analogue composition. In particularly the invention relates to a non-casein cheese analogue composition comprising water, fiber, starch, plant protein, lipid and whey protein.

The present invention relates to a non-casein cheese analogue composition. In particularly the invention relates to a non-casein cheese analogue composition comprising water, fiber, starch, plant protein, lipid and whey protein.

Cheese analogues are cheese-like products manufactured by blending various edible oils/fats, proteins, other ingredients, and water into a smooth homogeneous blend with the aid of heat, mechanical shear, and emulsifying salts. Cheese analogues were developed in the United States in the early 1970s, the main impetus being the desire to create cheaper cheese substitutes for the industrial and catering cheese sectors, where they have numerous applications: frozen pizza toppings, slices in beef burgers, and as an ingredient in salads, sandwiches, cheese sauces, cheese dips, and ready-prepared meals. The major protein source in dairy-based cheese analogues is casein, usually rennet casein, especially in semihard block cheese analogues; caseinates are used mainly in spreadable cheese analogues products. Owing to the high cost of caseins/caseinates, much effort has been vested in their partial replacement by cheaper casein substitutes. Vegetable proteins from various sources (soy, cottonseed, peanut, pea) have, in general, been found to give cheese analogues that are inferior to those made using casein only, common defects being lack of elasticity, an adhesive/sticky body, and impaired flow and stretchability. Whey proteins are not generally used in cheese analogues intended for cooking applications owing to the negative impact on flowability, except in applications where flow-resistant products may be needed (e.g., cheese inside the rim of a stuffed crust pizza). The adverse effect on flowability is due to heat-induced denaturation and aggregation and/or gelation of added whey proteins or whey protein/para-casein complexes on heating the cheese analogues, during preparation or subsequent cooking.

Typically, these cheese analogue compositions, without a casein component, have limitations according to melting properties in combination with tooth stickiness. Most of the available non-casein cheese analogues do not melt at all or not properly enough. In case a cheese analogue composition has excellent melting properties it has on the other side the negative effect of tooth stickiness.

The objective of the present invention is to provide a whey-protein containing cheese analogue composition (“non-casein cheese”) with modulated melting properties and tooth stickiness to achieve a balanced product. In addition, the non-casein cheese analogue composition should still be able to be shred. A further object of the present invention can be to provide a low sodium non-casein cheese analogue composition.

The objective of the present invention is achieved by the subject matter of the independent claims. The dependent claims further develop the idea of the present invention.

Accordingly, the present invention provides in a first aspect a non-casein cheese analogue composition comprising:
i) 35 to 60 wt % water (weight percent of the total composition);
ii) 0.1 to 10 wt % fiber (weight percent of the total composition);
iii) 5 to 20 wt % starch (weight percent of the total composition);
iv) 0.1 to 7 wt % plant protein (weight percent of the total composition);
v) 10 to 40 wt % lipid (weight percent of the total composition);
vi) 0.3 to 3.5 wt % whey protein (weight percent of the total composition).

The present invention provides in a second aspect a method of preparing a non-casein cheese analogue composition comprising the steps of:
a) mixing dry ingredients comprising 0.1 to 10 wt % of fiber (weight percent of the total composition), 5 to 20 wt % starch (weight percent of the total composition), 0.1 to 7 wt % plant protein (weight percent of the total composition), and 0.3 to 3.5 wt % whey protein (weight percent of the total composition) at room temperature;
b) adding 10 to 40 wt % lipid (weight percent of the total composition) and further mix;
c) adding 35 to 60 wt % water (weight percent of the total composition) and further mix;
d) heating the mixture from step c) to a temperature ranging from 70° C. to 90° C., until desired smooth, homogeneous texture is achieved;
e) optionally molding the mixture obtained in step d) to required shape;
f) cooling down to obtain the non-casein cheese analogue.

It has been surprisingly found by the inventors, that by using the above mentioned composition a non-casein cheese analogue can be obtained having modulated melting and tooth sticking parameters. It has been found by the inventors that by using 0.3 to 3.5 wt % whey protein (weight percent of the total composition), a balanced non-casein cheese analogue can be obtained having still good melting properties and reduced tooth stickiness.

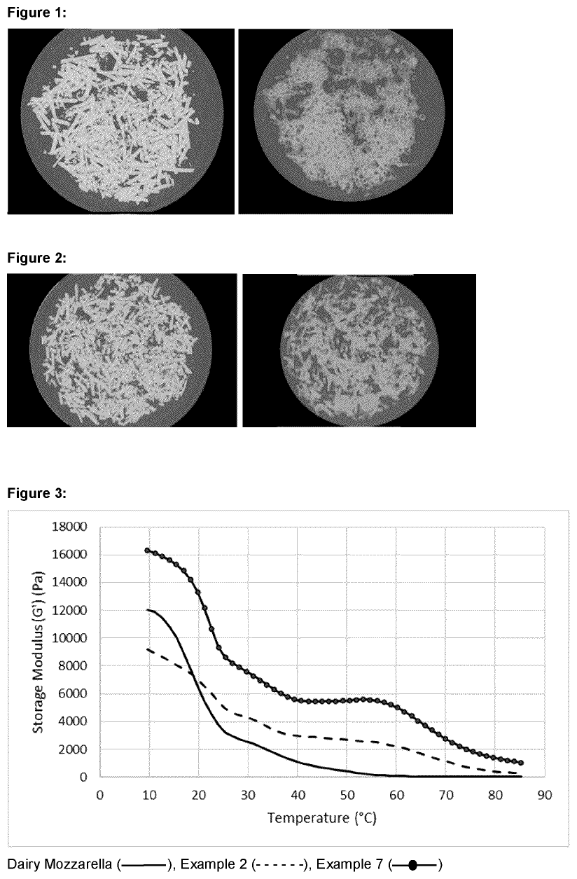

FIG. 1 shows the melting properties of a shredded composition with 1 wt % of whey protein before and after melting at 205° C. (400° F.) on a metal plate.

FIG. 2 shows the melting properties of a shredded composition with 2 wt % of whey protein before and after melting at 205° C. (400° F.) on a metal plate.

FIG. 3 shows rheology curves of a dairy Mozzarella cheese and of non-casein cheese analogues with 1 wt % and 2 wt % of whey protein.

All percentages expressed herein are by weight of the total weight of the non-casein cheese analogue unless expressed otherwise.

The term “non-casein cheese analogue” refer to replacements of cheese and are non-casein based food compositions. The term includes vegetarian cheeses intended to be used for salad bars and baked cheese food products such as pizzas and pasta.

In an embodiment of the present invention the non-casein cheese analogue comprises between 35 to 60 wt % (weight percent of the total composition) of water, preferably between 40 to 60 wt %, preferably between 40 to 55 wt %, preferably between 40 to 50 wt % (weight percent of the total composition).

“Fiber” according to this invention is a dietary fiber. Dietary fiber consists of the remnants of edible plant cells, polysaccharides, lignin and associated substances resistant to (hydrolysis) digestion by the alimentary enzymes of humans. The dietary fibers are from vegetables, fruits, cereal or combinations thereof. Dietary fibers are selected from at least one of carrot, beetroot, pumpkin, citrus, psyllium, pea, wheat, oat, potato, bamboo, tomato, bell pepper, leek, ginger, onion, kale, parsnip, celery, cucumber, courgette, broccoli, kohlrabi, asparagus or combinations thereof, preferably carrot, beetroot, pumpkin, citrus, psyllium, pea, wheat, oat, bamboo, tomato or combinations thereof, more preferably citrus, psyllium, pea or a combination thereof. The fibers or dietary fibers are in powdered form and have a particle size of from 5 μm to 1000 μm, preferably 5 μm to 1000 μm, preferably 5 μm to 800 μm, preferably 5 μm to 700 μm, preferably 5 μm to 500 μm, preferably 15 μm to 1000 μm, preferably 15 μm to 700 μm, preferably 15 μm to 500 μm, preferably 20 μm to 500 μm, preferably 50 μm to 800 μm, preferably 5 μm to 500 μm, preferably 75 μm to 700 μm, preferably 80 μm to 500 μm, preferably 100 μm to 600 μm, preferably 100 μm to 500 μm, preferably 250 μm to 500 μm. Particle size and particle size distribution may be measured by laser diffraction using a Malvern Mastersizer. In a further embodiment, the non-casein cheese analogue of the invention comprises fiber in the amount of 0.1 to 10 wt % (weight percent of the total composition), preferably 0.5 to 10 wt %, preferably 0.5 to 9 wt %, preferably 1 to 10 wt %, preferably 1 to 9 wt %, preferably 2 to 8 wt %, preferably 2 to 7 wt % (weight percent of the total composition).

The term “plant protein” includes “plant protein isolates” or “plant protein concentrates” or combination thereof. The person skilled in the art knows how to calculate the amount of plant protein within a plant protein concentrate or plant protein isolate. The term “plant protein concentrate” as used herein is a plant material having a protein content between 50-90% (plant protein on a moisture-free basis), preferably between 65-75% (plant protein on a moisture-free basis). Plant protein concentrate also contains plant fiber, typically from about 3.5% up to about 20% by weight on a moisture-free basis. The term plant protein isolate, as used herein is a plant material having a protein content of at least about 90% plant protein on a moisture free basis, preferably between 90-96% (plant protein on a moisture-free basis).

Plant protein include plant protein concentrate or plant protein isolate from pea protein, corn protein (e.g., ground corn or corn gluten), wheat protein (e.g., ground wheat or wheat gluten such as vital wheat gluten), potato protein, legume protein such as soy protein (e.g., soybean meal, soy concentrate, or soy isolate), rice protein (e.g., ground rice or rice gluten), barley protein, algae protein, hemp protein, oat protein, canola protein, fava protein or combinations thereof. Preferably the plant protein is, pea protein, canola protein, hemp protein, fava protein, potato protein, soy protein or a combination thereof, more preferably pea protein, soy protein, potato protein or a combination thereof. In a further embodiment, the non-casein cheese analogue of the invention comprises plant protein in the amount of 0.1 to 7 wt % (weight percent of the total composition), preferably 0.5 to 7 wt %, preferably 0.5 to 5 wt %, preferably 1 to 7 wt %, preferably 1 to 5 wt %, preferably 1 to 3 wt % (weight percent of the total composition).

“Starch” according to this invention has two main polysaccharides amylose and amylopectin. Starches granules can be isolated from a wide variety of plant sources, consisting of tuberous root, tuber and seeds. Based on the botanical origin, starch granules come in different shapes, sizes and have varying ratios of amylose/amylopectin. Starch according to this invention is a native starch, physically modified starch, flour, pre-gelatinized starch or cold swelling starch or combination thereof. In a further preferred embodiment, the non-casein cheese analogue does not contain a chemically modified starch. The starch according to the invention is selected from the group consisting of maize, waxy maize, high amylose maize, wheat, tapioca, rice, potato, cassava or combinations of these.

Corresponding flours can also be used as a source of starch. The person skilled in the art knows how to calculate, based on the amount of starch, how much flour has to be used to fall within this invention. Native starch is defined as a starch granule in its native form in the nature; isolated using the extraction processes. Native starch granule is in a semi-crystalline form and have a crystallinity varying from 15 to 45%. Other prominent feature of a native starch granule is its presence of Maltese cross when observed under polarized light. Due to the presence of the order in the native starch, it exhibits birefringence under polarized light. Gelatinized starch is the native starch, which undergoes gelatinisation process. The gelatinization process occurs when the native starch granules are heated progressively to higher temperatures in the presence of excess of water, the granules begin to irreversibly swell and there is a point at which the Maltese cross of the native granules disappears. During gelatinisation several events occur simultaneously. There are three distinct stages that occur in the gelatinization process: (i) granular swelling by slow water absorption; (ii) followed by a rapid loss of birefringence via the absorption of large amounts of water by the granules; and (iii) finally, leaching of the soluble portion into the solution, transforming the granules into formless sacs. Size, shape of the granule and the loss of birefringence are the distinctive feature of the gelatinized starch. Gelatinized starch can be sourced commercially as pre-gelatinized starch. Swollen starch granule or partly gelatinized is produced when the native starch granules are heated progressively to higher temperatures in the presence of excess of water; the granules begin to irreversibly swell and Swollen starch granule or partly gelatinized is an intermediate stage between the native starch granule form and gelatinisation. The granules in the swollen form have a larger granular size than the native starch granule and could have a partial or complete loss of birefringence. In a further embodiment, the non-casein cheese analogue of the invention comprises starch in the amount of 5 to 20 wt % (weight percent of the total composition), preferably 10 to 20 wt %, preferably 12 to 19 wt %, preferably 13 to 19 wt % (weight percent of the total composition).

In an embodiment of the present invention, the lipid is a vegetable fat, a vegetable oil or a combination thereof. In one embodiment of the present invention, the lipid is a vegetable oil selected from palm oil, rapeseed oil, sunflower oil, cotton seed oil, canola oil, peanut oil, soya oil, olive oil, coconut oil, algal oil, safflower oil, corn oil, rice bran oil, sesame oil, hazelnut oil, avocado oil, almond oil, walnut oil or a combination thereof, preferably rapeseed oil, sunflower oil or palm oil. In a preferred embodiment the lipid is a blend of coconut oil and sunflower oil, rape seed oil, cotton seed oil, peanut oil, soya oil, olive oil, algal oil, safflower oil, corn oil, rice bran oil, sesame oil, hazelnut oil, avocado oil, almond oil, walnut oil or canola oil. In one embodiment of the present invention, the non-casein cheese analogue product comprises between 10 to 40 wt % lipid (weight percent of the total composition), preferably between 15 to 40 wt %, preferably between 10 to 35 wt %, preferably between 15 to 35 wt %, preferably between 20 to 30 wt % (weight percent of the total composition). In an embodiment the lipid has a saturated fat content between 45 to 75% of the total fat, preferably 50 to 75% of the total fat, preferably 55 to 75% of the total fat, preferably 55 to 70% of the total fat, more preferably 60 to 70% of the total fat.

The term “whey protein” includes “whey protein isolates” or “whey protein concentrates” or combination thereof. The person skilled in the art knows how to calculate the amount of whey protein within a whey protein concentrate or whey protein isolate. The term “whey protein concentrate” as used herein is a whey material having a protein content between 50-90% (whey protein on a moisture-free basis), preferably between 65-75% (whey protein on a moisture-free basis). In an embodiment of the present invention the non-casein cheese analogue comprises between 0.3 to 3.5 wt % (weight percent of the total composition) of whey protein, preferably between 0.5 to 3.5 wt %, preferably between 0.5 to 3.2 wt %, preferably between 0.7 to 3.2 wt %, preferably between 1 to 3 wt % (weight percent of the total composition).

In an embodiment of the present invention the non-casein cheese analogue further comprises between 0.1 to 3 wt % (weight percent of the total composition) of glycerin, preferably between 0.2 to 3 wt %, preferably between 0.1 to 2.5 wt %, preferably between 0.1 to 2 wt %, preferably between 0.1 to 1.5 wt %, preferably between 0.2 to 1.5 wt % (weight percent of the total composition).

“Salt” according to this invention means edible salts capable of imparting or enhancing a salty taste perception. Salt is selected from the group consisting of sodium chloride, potassium chloride, ammonium chloride or a combination thereof, more preferably sodium chloride. In a further embodiment, the non-casein cheese analogue comprises salt in an amount in the range of 0.5 to 3 wt % (by weight percent of the total composition), preferably between 0.5 to 2.5 wt %, more preferably between 0.5 to 2 wt % (by weight percent of the total composition).

In a further embodiment, the non-casein cheese analogue composition has a storage modulus (G′) value between 50 to 4000 Pa at a temperature of 70° C., a constant shear strain 0.5%, and a constant frequency 1 Hz, preferably between 50 to 3000 Pa at a temperature of 70° C., a constant shear strain 0.5%, and a constant frequency 1 Hz.

In a further embodiment, the non-casein cheese analogue does not contain added gum. Gum according to this invention is xanthan gum, carrageenan, locust bean gum, agar, alginates, guar gum, arabic gum, gellan or combination thereof.

In a further embodiment, the non-casein cheese analogue does not contain an emulsifier selected from the group consisting of egg yolk, lecithin, soy lecithin, sunflower lecithin, sodium stearoyl lactylate, diacetyl tartaric ester of monoglyceride (DATEM), polyglycerol-polyricinoleate (PGPR), monoglyceride and mono-diglyceride or a combination thereof.

In a further embodiment, the non-casein cheese analogue does not contain emulsifying salt. In a further embodiment, the non-casein cheese analogue does not contain emulsifying salt selected from the group consisting of mono-, di-, and trisodium phosphates, dipotassium phosphate, sodium hexametaphosphate, sodium acid pyrophosphate, tetrasodium pyrophosphate, sodium aluminum phosphate, sodium citrate, potassium citrate, sodium tartrate, and sodium potassium tartrate or a combination thereof.

In an embodiment, the non-casein cheese analogue is a low sodium non-casein cheese analogue composition. In an embodiment, the non-casein cheese analogue have a total amount of sodium below 800 mg/100 g, preferably below 750 mg/100 g, preferably below 700 mg/100 g, preferably below 650 mg/100 g, preferably between 200 mg/100 g to 800 mg/100 g, preferably between 300 mg/100 g to 800 mg/100 g, preferably between 400 mg/100 g to 800 mg/100 g, preferably between 500 mg/100 g to 800 mg/100 g, preferably between 600 mg/100 g to 800 mg/100 g, preferably between 200 mg/100 g to 750 mg/100 g, preferably between 200 mg/100 g to 700 mg/100 g.

### EXAMPLES

### Example 1: Process

Vegan cheese samples were made in 2-Kg batches using Stephan kettle. The dry ingredients were blended in the Stephan cooker. Fat component was added and mixed at slow speed to disperse the dry-ingredients and avoid forming lumps. Water was subsequently added; the blend was mixed at maximum speed-setting of II (i.e. 1500 rpm) and heated to a temperature of 80° C. and held for 2 min before packing in a plastic container and cooling in a walk-in cooler (4° C. or lower). Samples were stored for at least 10 days at 4° C. before shredding. Allowing the samples to equilibrate for 10 days appeared to have improved shredding properties.

### Melt Score and Tooth Sticking:

Samples were evaluated on pizza crusts topped with non-casein cheese analogues. The panelists evaluated one sample at a time, scoring based on intensity for each attribute (0-5 scale).
Melt score 0=visible shreds after cooking 5=no shreds after baking, full melt
Tooth sticking 0=no sticking 5=max sticking

### Peak Force and Area Using Texture Analyzer:

Texture profile analysis (TPA) was carried out using a TAXT2i texture analyzer (Stable Micro Systems, Godalming, UK). The TPA curves were used to derive the instrumental texture attributes including Peak force and Area, both of which are indicators of hardness, which can be defined as the force necessary to attain a given deformation.

In this method, five representative samples of cheeses were cut into a cylinder shape (dimensions: 20 mm diameter and 20 mm height). A double bite compression method was used with a rest period of 2 seconds between the two bites. The samples were compressed to 80% (16 mm compression) of their original height using a 50 mm cylindrical flat probe with a crosshead speed of 0.8 mm/s.

### G′ at 50° C., 60° C., and 70° C. Using Dynamic Oscillatory Rheometry:

Dynamic Oscillatory Rheometry offers a method to indirectly probe the structure of cheese analogues over a range of experimental time scales, extents of deformation, and temperatures. Small amplitude oscillations are imposed upon the cheese analogue sample, such that the strains are within the linear viscoelastic region where any structural breakdown is largely reversible within the time-scale of the experiment. Exceeding this limit causes the cheese analogue structure to change and re-form into a different conformation upon cessation of the oscillatory strain. The experimental time scale is defined as the reciprocal of the oscillation frequency. Large time scale experiments (at slow frequency) allow sufficient time for flow units within a sample to move and rearrange during the experiment, thus the sample is more fluid-like. Short time scale experiments do not allow sufficient time for the flow units to move, thus the sample is more solid-like.

The degree of solidness is quantified by the elastic storage modulus (G′). The elastic modulus is calculated from the ratio of stress to strain, so for a given applied stress, any factor that reduces the strain will increase the elasticity and firmness. For high values of G′, the material is more solid or gel-like, whereas lower values indicate a more fluid-like substance.

Analysis was conducted using MCR 200 (Anton Paar), PP25/P2 Serrated Parallel Plate Geometry, and H-PTD200 Peltier Temperature Control Device. Samples were cut in to 25 mm diameter and 2 mm thickness, and were allowed to temper to refrigerated conditions prior to use. AntonPaar software was used to operate the rheometer and record and analyze data. The water bath and the compressed air were turned on. The normal force was reset and that the height was calibrated, every time prior to running a sample. The cheese analogue disc was placed in the center of the bottom plate and the measurement height was selected. The hood was lowered and made sure that the temperature was set to 20° C. The cheese analogue was allowed to temper for 5 to 10 minutes before running the test. Temperature of sample was increased from 20° C. to 90° C. at the rate of 1° C. per minutes and storage modulus (G′) was recorded at constant shear strain 0.5% and constant frequency 1 Hz.

### Examples 2 to 7

Examples 2 to 7 have been prepared according to example 1.

| | Comp. | | |
|---|---|---|---|
| Ingredient | Example 1 | Example 2 | Example 3 |
| Water [wt %] | 50 | 50 | 49 |
| Pea Fiber [wt %] | 3 | 3 | 3 |
| Potato starch [wt %] | 16.7 | 16.7 | 16.7 |
| Potato protein [wt %] | 1.8 | 1.8 | 1.8 |
| Coconut oil [wt %] | 18.25 | 18.25 | 18 |
| Sunflower oil [wt %] | 6.75 | 6.75 | 6 |
| Rice Flour [wt %] | 1.1 | 0.1 | 0.1 |
| Glycerin [wt %] | 0.3 | 0.3 | 0.3 |
| Lactic acid [wt %] | 0.1 | 0.1 | 0.1 |
| Salt [wt %] | 2 | 2 | 2 |
| WPI [wt %] | — | 1 | 3 |
| Melt score | 5 | 4.5 | 2.5 |
| Tooth sticking | 5 | 3 | 1 |
| Sodium (mg/100 g) | 800 | 800 | 800 |
| Peak force | 78 | 68 | 60 |
| Area | 644 | 491 | 352 |
| G′ at 50 C. | 825 | 2667 | 5484 |
| G′ at 60 C. | 442 | 2070 | 4712 |
| G′ at 70 C. | 140 | 990 | 2748 |

| Ingredient | Example 4 | Example 5 |
|---|---|---|
| Water [wt %] | 46.4 | 47.9 |
| Citrus Fiber [wt %] | 3 | 5 |
| Potato starch[wt %] | 16.7 | 16.7 |
| Soy protein [wt %] | 1.8 | 1.8 |
| Coconut oil [wt %] | 21 | 18.25 |
| Soybean oil [wt %] | 7 | 6.75 |
| Glycerin [wt %] | 1 | 1 |
| Lactic acid [wt %] | 0.1 | 0.1 |
| Salt [wt %] | 2 | 2 |
| WPI | 1 | 0.5 |
| Melt score | 4 | 4.5 |
| Tooth sticking | 3 | 4 |
| Sodium (mg/100 g) | 800 | 800 |
| Peak force | 83 | 82 |
| Area | 661 | 633 |
| G′ at 50 C. | 4709 | 4493 |
| G′ at 60 C. | 1825 | 1821 |
| G′ at 70 C. | 217 | 94 |

| Ingredient | Example 6 | Example 7 |
|---|---|---|
| Water [wt %] | 44.9 | 47.9 |
| Psyllium Fiber [wt %] | 5 | 5 |
| Corn starch [wt %] | 16.7 | 16.7 |
| Pea protein [wt %] | 1.8 | 1.8 |
| Coconut oil [wt %] | 21 | 18.25 |
| Canola oil [wt %] | 7 | 6.75 |
| Glycerin [wt %] | 1 | — |
| Lactic acid [wt %] | 0.1 | 0.1 |
| Salt [wt %] | 1 | 1.5 |
| WPI [wt %] | 1.5 | 2 |
| Melt score | 3.5 | 3.5 |
| Tooth sticking | 2.5 | 2 |
| Sodium (mg/100 g) | 390 | 590 |
| Peak force | 91 | 72 |
| Area | 707 | 477 |
| G′ at 50 C. | 4808 | 5145 |
| G′ at 60 C. | 3225 | 3918 |
| G′ at 70 C. | 867 | 1195 |

Comparative example 1 to example 7 show the influence of whey protein (WPI) to modulate the melting properties and tooth stickiness of a non-casein cheese analogue. Without whey protein (comp. example 1) the non-casein cheese analogue has the best melting rating but also is the worse example regarding tooth stickiness. A balanced rating between melting properties and tooth stickiness can be achieved if the non-casein cheese analogue composition comprises between 0.3 to 3.5 wt % whey protein. Above 3.5 wt % of whey properties the melting properties of the non-casein cheese analogue will be lost.

FIG. 1 shows the melting properties of example 2 with 1 wt % of whey protein before and after melting at 205° C. (400° F.) on a metal plate.

FIG. 2 shows the melting properties of example 7 with 2 wt % of whey protein before and after melting at 205° C. (400° F.) on a metal plate.

FIG. 3 shows rheology curves of a dairy Mozzarella cheese and of examples 2 and 7.

1. A non-casein cheese analogue composition comprising:
i) 35 to 60 wt % water (weight percent of the total composition);
ii) 0.1 to 10 wt % fiber (weight percent of the total composition);
iii) 5 to 20 wt % starch (weight percent of the total composition);
iv) 0.1 to 7 wt % plant protein (weight percent of the total composition);
v) 10 to 40 wt % lipid (weight percent of the total composition); and
vi) 0.3 to 3.5 wt % whey protein (weight percent of the total composition).

2. A non-casein cheese analogue composition as claimed in claim 1, wherein the fiber is a dietary fiber.

3. A non-casein cheese analogue composition according to claim 1, wherein the fiber is selected from the group consisting of pea, citrus, psyllium, carrot, beetroot, pumpkin, wheat, oat, bamboo, tomato, potato, bell pepper, leek, ginger, onion, kale, parsnip, celery, cucumber, courgette, broccoli, kohlrabi, asparagus or and combinations thereof.

4. A non-casein cheese analogue composition according to claim 1, wherein the starch is selected from the group consisting of maize, waxy maize, high amylose maize, wheat, tapioca, rice, potato, cassava and combinations thereof.

5. A non-casein cheese analogue composition according to claim 1, wherein the plant protein is selected from the group consisting of soy, pea, potato, corn, wheat, rice, barley, algae, hemp, oat, canola, fava and a combination thereof.

6. A non-casein cheese analogue composition according to claim 1, wherein the lipid has a saturated fat content between 45 to 75% of the total fat.

7. A non-casein cheese analogue composition according to claim 1, wherein the lipid is a blend of coconut oil and a vegetable oil.

8. A non-casein cheese analogue composition according to claim 1, wherein the lipid is a blend of coconut oil and sunflower oil, rape seed oil, cotton seed oil, peanut oil, soya oil, olive oil, algal oil, safflower oil, corn oil, rice bran oil, sesame oil, hazelnut oil, avocado oil, almond oil, walnut oil and canola oil.

9. A non-casein cheese analogue composition according to claim 1, wherein the non-casein cheese analogue composition has a storage modulus (G′) value between 50 to 4000 Pa at a temperature of 70° C., a constant shear strain 0.5%, and a constant frequency 1 Hz.

10. A non-casein cheese analogue composition according to claim 1, wherein the non-casein cheese analogue composition further comprises 0.1 to 3 wt % glycerin.

11. A non-casein cheese analogue composition according to claim 1, wherein the non-casein cheese analogue composition further comprises 0.5 to 3 wt % salt.

12. A non-casein cheese analogue composition according to claim 1, wherein the non-casein cheese analogue composition has a total amount of sodium below 800 mg/100 g.

13. A method of preparing a non-casein cheese analogue composition comprising:
i) 35 to 60 wt % water (weight percent of the total composition);
ii) 0.1 to 10 wt % fiber (weight percent of the total composition);
iii) 5 to 20 wt % starch (weight percent of the total composition);
iv) 0.1 to 7 wt % plant protein (weight percent of the total composition);
v) 10 to 40 wt % lipid (weight percent of the total composition); and
vi) 0.3 to 3.5 wt % whey protein (weight percent of the total composition) comprising the steps of:
a) mixing dry ingredients at room temperature;
b) adding lipid and further mix;
c) adding water and further mix;
d) heating the mixture from step c) to a temperature ranging from 70° C. to 90° C., until desired smooth, homogeneous texture is achieved; and
e) cooling down to obtain the non-casein cheese analogue.

14. (canceled)
